(19) United States
(12) Patent Application Publication
(10) Pub. No.: US 2010/0057529 A1
(43) Pub. Date: Mar. 4, 2010

(54) PROVIDER-REQUESTED RELOCATION OF COMPUTERIZED WORKLOADS

(75) Inventors: Gregory J. Boss, American Fork, UT (US); James R. Doran, New Milford, CT (US); Rick A. Hamilton, II, Charlottesville, VA (US); Anne R. Sand, Peyton, CO (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/203,399

(22) Filed: Sep. 3, 2008

(51) Int. Cl. G06Q 50/00

(52) U.S. Cl. 705/10

(57) ABSTRACT

Power or energy providers are enabled to request and initiate the relocation of customer computational workloads to other energy providers or other locations during critical situations, such as weather crises, national emergencies, power distribution interruptions, or equipment upsets. Workloads may be pre-registered and automatically relocated by the provider based on conditions of agreements between the provider and the customer. Alternatively, provider-initiated requests may be broadcast to all customers or specified subscribed customers giving them the ability to redirect the workloads as desired. The workloads may be re-allocated based upon such factors as lower costs, time shifts or quality of service contract provisions. The re-allocation serves to minimize or eliminate the potential adverse impact on the customer while maintaining a level of service that is satisfactory to the customer.

### BACKGROUND OF THE INVENTION

This invention relates to enabling a power provider, such as an electric utility, to request a customer to re-allocate all or part of a computational workload. In particular, it relates to electric utilities and provides them with the capability of customer computational workload shifting based on probabilities of the occurrence of future events that might adversely affect the ability of the utilities to maintain a given level of service to their customers.

### FIELD OF THE INVENTION

Both predictable and unpredictable events may cause power providers to reach maximum capacity and desire that customers redirect their workloads to other sources. For example, certain times of day are peak power usage times. Providers may want particular customers to move workloads to another location, another provider, or another time during these peak periods to mitigate the chances of overload-induced power slowdowns, brownouts or blackouts.

Highly populated areas, such as large cities, are prone to power shortages. Also, natural disasters, weather situations and other incidents may cause power shortages in any given area. Currently, efficient and automated methods do not exist for energy providers to communicate with customers about the need for power load relocation or reallocation. Additionally, methods do not exist for providers to automatically initiate the redistribution of computational workloads.

### SUMMARY OF THE INVENTION

For purposes of the present invention, power is defined as the electric energy resource used by businesses and individual customers over a given period of time.

This invention relates to an infrastructure and methods for enabling power providers to request customers to relocate their computational workload. This invention may utilize the framework described in co-pending patent application Ser. No. ______, dated ______ entitled FRAMEWORK FOR DISTRIBUTION OF COMPUTER WORKLOADS BASED ON REAL TIME ENERGY COSTS, the methods described in co-pending patent Ser. No. ______, dated _______ entitled ANALYSIS OF ENERGY-RELATED FACTORS FOR SELECTING COMPUTATIONAL JOB LOCATIONS and the in-band power communication described in co-pending application Ser. No. ______, dated ______ entitled POWER METADATA TRANSFER OVER POWER LINES. Optionally, this invention may utilize other frameworks and distribution methods for negotiation of power rates.

A request, agreement, and initiation to relocate or re-allocate may be set up to occur automatically based on configurable thresholds. This enables efficient management of the use of power without requiring human intervention.

Relocation or re-allocation may involve moving a computational job to a different geographical location, different time, different service provider or a different power source. Additionally, providers may offer to relocate customer workloads to lower-cost providers to create goodwill and/or collect a brokering fee.

The present invention relates to a method and a system to enable a power provider to re-allocate a computational workload for performing a customer job. This invention is achieved by detecting a service situation having a potential impact on the future quality of service to be offered by the provider to the customer. A customer is notified of a quality of service situation, after which re-allocation of the workload is initiated with the approval of the customer. A workload request coordinator may be utilized or deployed through whom notification by the provider to the customer and approval by the customer are communicated. This coordinator serves as an intermediary between one or more provider and multiple customers. Arrangements are made to communicate between a provider and multiple customers. This may be done either in a broadcast mode to all customers or to targeted customers. The re-allocation can be based on factors such as job timing or lower costs.

The invention also relates to a computer-readable medium and a computer product containing sets of instructions, when implemented on a computer, for executing the steps of the invention, thereby enabling a power provider to re-allocate the power workload for a customer job. These steps include detecting a future service situation having a potential adverse impact on the quality of service to be offered by a power provider to the customer; notifying the customer of the future service situation; and based on said notification and a favorable response by the customer, initiating a re-allocation of a customer workload.

Finally, the invention relates to a method for deploying the implementation by a service provider such as the workload coordinator for re-allocating power workload for a customer job. Upon detecting a future service situation having a potential adverse impact on the quality of service offered by said power provider to a customer, the service provider notifies the customer of the service quality situation. Based on said notification and favorable response by the customer, the service provider initiates a re-allocation of a customer's workload on behalf of the power provider. The service provider would typically be selected by the power provider, but may instead be chosen by the customer.

### BRIEF DESCRIPTION OF THE DRAWINGS

These and other features of this invention will be more readily understood from the following detailed description of the various aspects of the invention taken in conjunction with the accompanying drawings in which:

FIG. 1 shows the workload coordination for managing requests of two providers and responses of multiple customers;

FIG. 2 represents a flow diagram showing implementation of the present invention; and

FIG. 3 is a block diagram illustrating an exemplary computerized system and method for implementing the present invention.

The drawings are not intended to be drawn to scale. Instead, the drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE INVENTION

As previously mentioned, a simplified definition of power is the electric energy resource used over a given unit of time.

Many options are disclosed for notification and response of workload redistribution. Overall steps include:
1. (Optional) Computational workloads of a customer may be pre-registered with a power provider;
2. The provider alerts a third party service coordinator or the customer of a need to redistribute;
3. Alternate provider options are examined by the customer or the power provider;
4. The customer responds with selection of the same power provider or an alternate provider;
5. Workload is redirected by customer, or power provider, or third party service coordinator;
6. Power levels are eventually stabilized, providing an option to return workload to original location, or complete the workload with the alternate provider; and
7. (Optional) Incentives may be provided for relocation.

Power providers may use both currently known and short-term forecasted input data to determine workload relocation requirements. For example, a provider may see that a hurricane is approaching a particular coastal area. Although the event may be days away, the provider may proactively take action to ask customers to relocate or re-allocate the priority of their compute jobs. As another example, prediction of a heat wave may cause air conditioning costs in an area to increase, prompting a movement of work to a cooler geographical area.

Additionally, power providers may have pre-negotiated Quality of Service (QoS) contracts with customers. In this case, the customers will not want to have a power shortage that would disrupt service. It may be more profitable or desirable for the providers to sacrifice particular customer workloads to prevent an outage or to maintain a high quality of service for other customers.

Following are options for implementation of this invention:
Requests for relocation and responses may be sent via any known communications medium, including over the internet or power signal.
Providers may offer incentives to customers to move their workloads to another provider.
Publish or subscribe options may be used for alerting and communicating.
Customers may register an overall quantity of work that may be redistributed, or alternately register individual work jobs.
Communications among customers and providers may be handled directly or through a third party coordinator referred to as a workload request coordinator.

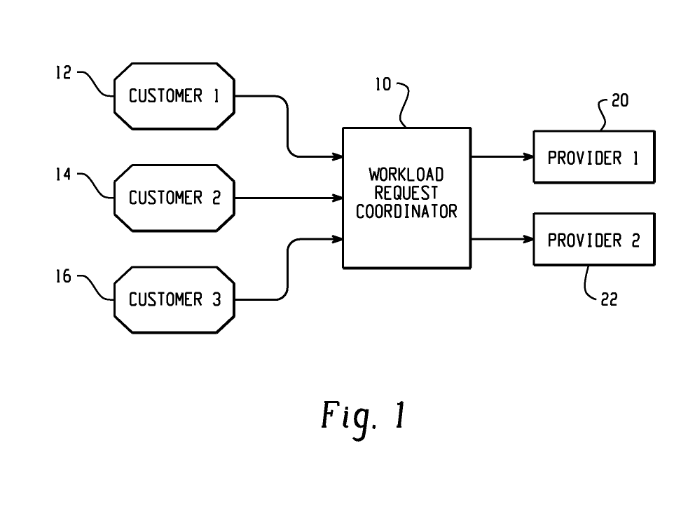

FIG. 1 shows a workload request coordinator that manages requests and responses among providers and customers. This coordinator may be used in lieu of direct communication among parties. The workload request coordinator 10 is shown along with three customers and two providers. Customer #1 (12), customer #2 (14), and customer #3 (16) are members or subscribers to a coordination program that utilizes the coordinator 10 to allocate the workload among available service providers, two of which are shown as provider 1 (20) and provider 2 (22).

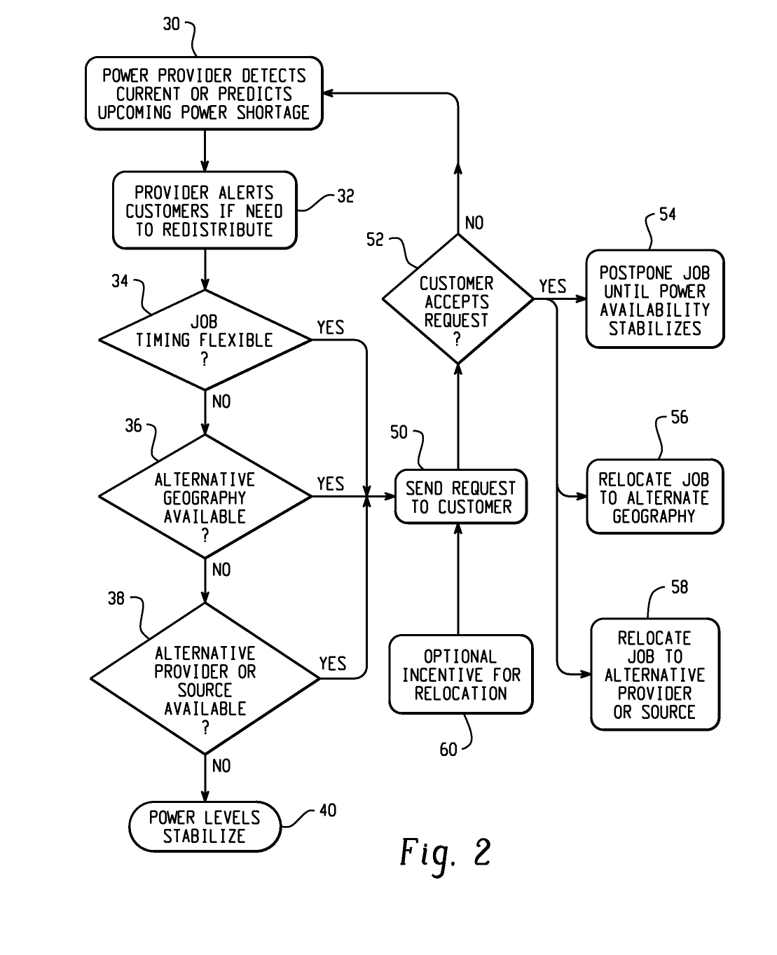

Turning now to FIG. 2, the process flow according to an embodiment of the present invention is shown. For purposes of discussion, the flow chart involves customer #1 (12) and provider #1 (20) (shown in FIG. 1). The provider detects or predicts a power shortage at 30 and alerts customer #1 at 32. The alert may be directly between the provider and the customer, or can be through the workload request coordinator 10 shown in FIG. 1. Either the provider or the customer then determines at 34 if the timing of a scheduled task is flexible. If timing is flexible, a request for change is entered at 50 but, if not, the availability of alternative geography is considered at 36. Again, a ‘yes’ message or signal is sent to customer at 50, either directly or through the workload request coordinator 10. But if the answer is in the negative, a query is entered at 38 concerning the availability of an alternative provider or source. If the response is ‘none available’, then the power levels are indicated as being stabilized at 40. If, however, the answer is ‘yes’, a request is sent to a customer at 50. If the job timing is flexible, then the provider postpones the job at 54 until the power availability stabilizes. If an alternative geographical location is available, then the job is relocated at 56 to an alternate location. If an alternative source or provider is available at 38, then the job is relocated at 58. If the customer does not accept the request at 52, then the refusal is communicated back to the power provider at 30. An optional incentive 60 may be used by the power provider or by the workload coordinator to attract the customer to agree to the change.

Following are four scenarios to illustrate the invention: (a) broadcast request, (b) targeted request to subscriber customers, (c) provider redirects workload on behalf of customer, and (d) time-based relocation. These are discussed in greater detail as follows.

### (a) Broadcast Request:

Provider detects power shortage,
Provider broadcasts to all customers requesting workload redistribution,
Each customer is able to redirect its workloads in response to the request, and
Workloads are redirected to other providers.

### (b) Targeted Requests to Subscribed Customers

Customer registers with system,
Customer indicates relocation options (e.g. amount and timing of work that may be relocated, locations that can accept the work),
Customer subscribes for alerts,
Provider detects power shortage,
Provider queries database of customers most likely to be able to redistribute workload,
Provider notifies those subscription customers of request to redistribute,
Customers able to redirect respond to provider, and
(Optional) Incentives may be provided to customers for relocation.

### (c) Provider Redirects Workload on Behalf of Customer

Provider detects current or predicts upcoming power shortage,
Provider queries database of customers most likely to be able to redistribute workload,
Provider notifies those customers of request to redistribute,
Customers able to redirect respond to provider,
Provider researches and recommends other locations and sources for power,
Provider redirects workload on behalf of customer, based on customer's prior authorization, and
Workload is returned to original provider when situation is stabilized, and the power output is returned to steady state.

### (d) Time-Based Relocation

Some compute jobs have the flexibility to be run in batch mode or queued to be run at a later time, such as off-hours when the peak load is reduced. Scientific compute jobs run by university students are an example of a type of job that would consume large compute resources (which require power to run and cool). Since these are research tasks, they may be more flexible on timing for job execution than real-time business transactions.

Steps for performing time-based relocation
1. Provider detects current or predicts upcoming power shortage;
2. Provider notifies customer of shortage and requests job timing flexibility;
3. Customer examines workload in queue to determine if any currently running or queued jobs may be postponed;
4. Customer notifies provider of listing of jobs that may be delayed and time frames for running jobs;
5. Optionally, provider and customer negotiate and agree to discounted pricing for customer's timing flexibility;
6. Job is put into wait state;
7. When provider's capacity issue is resolved, customer is automatically notified and job is automatically initiated.

A provider may initiate a relocation based on lower costs. Some insurance companies have built their business model around providing the customer with price quotes for the lowest provider, even if it is a competitor. The theory is that customers will appreciate their honesty and effort to save them money and select them as the insurance provider. This has not traditionally been the business model in the energy business. Although transferring all work to a competitor would not be a sound business decision, moving selected, contained workloads to a competitor may save money for the customer, create goodwill on behalf of the provider, and offer the opportunity for a commission for brokering the deal. This could involve the following steps:
Customer registers relocatable compute workloads with its primary provider,
The primary provider detects that a second provider can offer a lower price for the given workload, The primary provider automatically initiates transfer of work to the second provider,
(Optional) The primary provider is given a commission or other incentive for brokering the deal with the second provider.

### Computerized Implementation

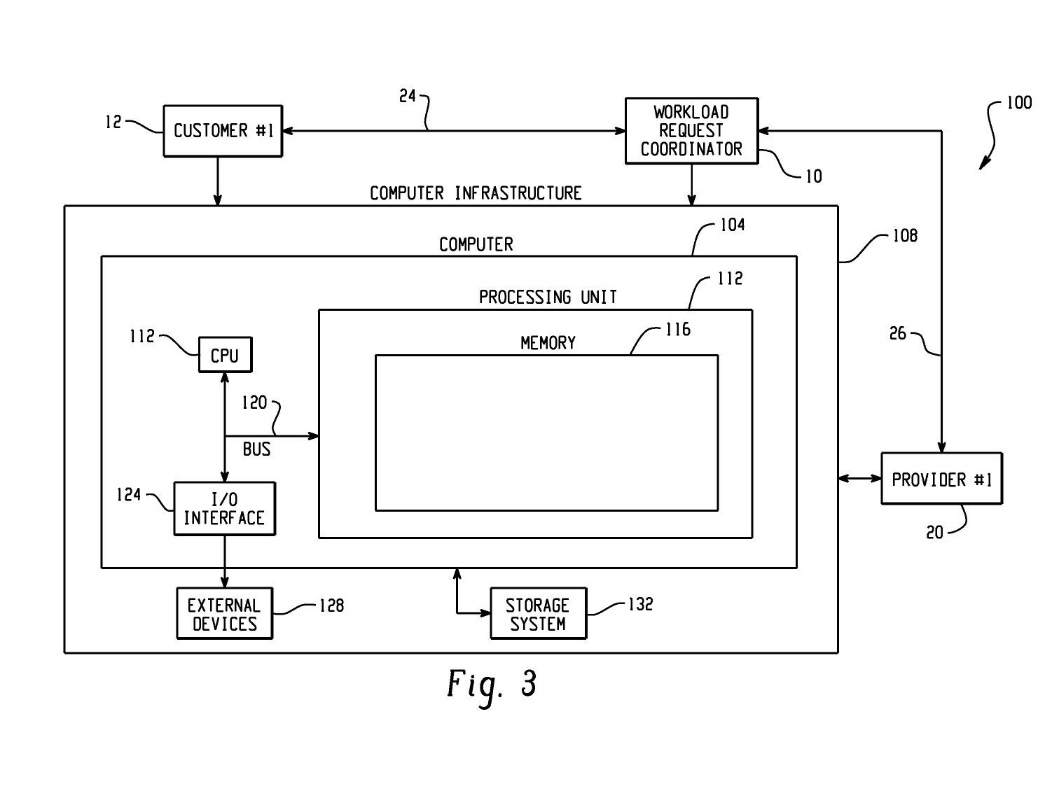

FIG. 3 shows communication links between a customer 12, a workload request coordinator 10 and an implementation of a computer system 100. The exemplary computer system 100 useful in carrying out the present invention includes a computer 104 deployed within a computer infrastructure 108, such as one existing at the information technology center of a business firm, a manufacturing company or governmental agency. This FIG. 3 is intended to demonstrate, among other things, that the present invention may be implemented within a network environment (e.g., the Internet, a wide area network (WAN), a local area network (LAN), a virtual private network (VPN), etc.), or on a stand-alone computer system.

In the case of a network environment, communication throughout the network can occur via any combination of various types of communication links. For example, the communication links can comprise addressable connections that may utilize any combination of wired and/or wireless transmission methods.

Where communications between a power provider and its customer occur via the Internet, connectivity could be provided by conventional TCP/IP socket-based protocol, and an Internet service provider could be used to establish connectivity to the Internet. Still yet, the computer infrastructure 108 is intended to demonstrate that some or all of the components of implementation could be deployed, managed, serviced, etc. by a service provider who offers to implement, deploy, and/or perform the functions of the present invention for others, such as the power provider or the customer.

As shown, the computer 104 includes a processing unit 112, a memory 116, a bus 120, and input/output (I/O) interfaces 124. Further, the computer 104 is shown in communication with external I/O devices/resources 128 and storage system 132. In general, the processing unit 112 executes computer program code, such as the code to implement various components of the computer 104, which are stored in memory 116 and/or storage system 132. It is to be appreciated that two or more, including all, of these components may be implemented as a single component.

While executing computer program code, the processing unit 112 can read and/or write data to/from the memory 116, the storage system 132, and/or the I/O interfaces 124. The bus 120 provides a communication link between each of the components in computer 104. The external devices 128 can comprise any devices (e.g., keyboard, pointing device, display, etc.) that enable a user to interact with computer 104 and/or any devices (e.g., network card, modem, etc.) that enable computer to communicate with one or more other computing devices.

The computer infrastructure 108 is only illustrative of various types of computer infrastructures for implementing the invention. For example, in one embodiment, the computer infrastructure 108 comprises two or more computing devices (e.g., a server cluster) that communicate over a network to perform the various process steps of the invention. Moreover, the computer 104 is only representative of various possible computer configurations that can include numerous combinations of hardware.

To this extent, in other embodiments, the computer 104 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively.

Moreover, the processing unit 112 may comprise a single processing unit, or be distributed across one or more processing units in one or more locations, e.g., on a client and server. Similarly, the memory 116 and/or the storage system 132 can comprise any combination of various types of data storage and/or transmission media that reside at one or more physical locations.

Further, the I/O interface 124 can comprise any system for exchanging information with one or more of the external device 128. Still further, it is understood that one or more additional components (e.g., system software, math co-processing unit, etc.) not shown in FIG. 3 can be included in the computer 104. However, if the computer 104 comprises a handheld device or the like, it is understood that one or more of the external devices 128 (e.g., a display) and/or the storage system 132 could be contained within the computer 104, not externally as shown.

The storage system 132 can be any type of system (e.g., a database) capable of providing storage for information under the present invention. To this extent, the storage system 132 could include one or more storage devices, such as a magnetic disk drive or an optical disk drive. In another embodiment, the storage system 132 includes data distributed across, for example, a local area network (LAN), wide area network (WAN) or a storage area network (SAN) (not shown). In addition, although not shown, additional components, such as cache memory, communication systems, system software, etc., may be incorporated into the computer 104.

As shown in FIG. 3, provider #1 and customer #1 (12) communicate with the workload request coordinator 10 along a wired or wireless route 24. The coordinator 10 is shown as a stand-alone device outside of the computer infrastructure 108. It should also be understood that that the services of a workload request coordinator 10 can be incorporated into the programming of the computer infrastructure 108. The provider 20 can make its request known to customer #1 (12) by sending the request directly through the computer 104 or, alternatively, along wired or wireless path 26 directly through the workload request coordinator 10 and then from the coordinator to the customer 12 along wired or wireless path 24. In the illustrated embodiment, the computer system 104 communicates with external entities 128, such as another computing system, an external system communicating with the controller 112, over a path, which may be a wired bus 120 (as shown) or wireless.

While shown and described herein as a method and a system, it is understood that the invention further provides various alternative embodiments. For example, in one embodiment, the invention provides a computer-readable/useable medium that includes computer program code to enable a computer infrastructure to perform the process steps of the invention. To this extent, the computer-readable/useable medium includes program code that implements each of the various process steps of the invention.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 116 and/or the storage system 132 (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider could offer to manage the computer 104. In this case, the service provider can create, maintain, and support a computer infrastructure, such as the computer infrastructure 108 that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for executing the computer 104. In this case, a computer infrastructure, such as computer infrastructure 108, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer 104 from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation, and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for a power provider to employ a re-allocation of a computational workload for a customer comprising the steps of:
a. detecting a service situation having a potential adverse impact on the future quality of service to be offered by the provider to the customer; and
b. based on an approval by the customer, initiating the re-allocation of said workload to minimize the potential adverse impact and maintain a satisfactory level of service.

2. The method according to claim 1 wherein the approval of the customer is based either upon a prior understanding between the provider and the customer or upon specific approval being given by the customer when notified by the provider, of an issue concerning the future quality of service.

3. The method according to claim 1 including the step of using a workload request coordinator through whom specific notification is communicated to the customer and approval given by the customer to re-allocate the workload is communicated to the provider.

4. The method according to claim 1 wherein approval is obtained from multiple customers.

5. The method according to claim 1 wherein the potential adverse impact is communicated by the provider to individual targeted customers, or by broadcast to multiple customers.

6. The method according to claim 1 wherein the approval by the customer includes authorization for the provider to re-allocate power capacity to a secondary power provider.

7. The method according to claim 1 wherein the step of re-allocation is based either on job timing or lower costs.

8. A system to enable a power provider to re-allocate a computational workload for a customer compute job, comprising:
a. a detector for sensing a service situation having a potential adverse impact on the future quality of service to be offered by the provider to a customer; and
b. based upon approval of the customer, an initiator for re-allocation of the workload to minimize the potential adverse impact and to maintain the level of service.

9. The system according to claim 8 wherein the approval of the customer is based either upon a prior understanding between the power provider and the customer, or upon specific approval by the customer when notified by the provider of an issue concerning the future quality of service.

10. The system according to claim 8 further including a workload request coordinator through whom notification by the power provider to the customer and approval by the customer are communicated.

11. The system according to claim 10 wherein the workload request coordinator serves as an intermediary between at least one power provider and multiple customers.

12. The system according to claim 11 including the capability for the power provider to communicate by broadcast to all customers or selectively to targeted customers.

13. The system according to claim 8 wherein the authorization enables the provider to re-allocate the workload to a secondary power provider.

14. A computer-readable medium containing instructions, when implemented on a computer, for:
a. detecting a future service situation having a potential adverse impact on the quality of service to be offered by a power provider to the customer;
b. notifying the customer of the future service situation;
c. based on said notification and a favorable response by the customer, initiating a re-allocation of a customer workload.

15. The medium according to claim 14 further including an instruction to route communication between the power provider and the customer through a workload request coordinator.

16. The medium according to claim 15 further including instructions to communicate between said power provider and multiple customers, and further instructions to communicate by broadcast to all customers or to individual targeted customers.

17. For use by a power provider, a computer product including a medium on which a computer program is recorded, said computer program including a first set of instructions for detecting a future service situation having a potential adverse impact on the quality of service offered by a power provider to a customer; a second set of instructions for notifying the customer of the service situation; and, based on said notification and favorable response by the customer, a third set of instructions for initiating a reallocation of the customer's workload.

18. The computer product according to claim 17 wherein the computer program also includes an instruction to route communication between the power provider and the customer through a workload request coordinator.

19. The computer product according to claim 18 wherein the program further includes instructions to communicate between the power provider and multiple customers, either by broadcast with all customers or to targeted customers of the power provider.

20. The computer product according to claim 17 wherein the program includes instructions to the provider to re-allocate the power workload to a secondary power provider.

21. A method for deploying an application for servicing a power provider by:
a. detecting a future service situation having a potential adverse impact on the quality of service offered by said power provider to a customer,
b. notifying the customer of the service quality situation; and
c. based on said notification and favorable response by the customer, initiating a re-allocation of a customer's workload on behalf of the power provider.

22. The method according to claim 21 further providing the service of routing communication between the provider and the customer through a workload request coordinator.

23. The method according to claim 21 further including providing communication between a provider and multiple customers, including communication by broadcast to all customers or to targeted customers.

24. The method according to claim 23 wherein the method is deployed through the workload request coordinator.

25. The method according to claim 21 wherein the method is deployed to enable the provider to re-allocate the workload to a secondary power provider.
